(19) United States
(12) Patent Application Publication
(10) Pub. No.: US 2011/0102826 A1
(43) Pub. Date: May 5, 2011

(54) IMAGE FORMING APPARATUS, DOCUMENT MANAGING SYSTEM, AND DOCUMENT MANAGING METHOD

(75) Inventors: Akihiko Fujiwara, Kanagawa-ken (JP); Kazuhiro Ogura, Kanagawa-ken (JP); Toshihiro Ida, Shizuoka-ken (JP); Hajime Tomizawa, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/882,687

(22) Filed: Sep. 15, 2010

Related U.S. Application Data
(60) Provisional application No. 61/256,538, filed on Oct. 30, 2009.

(51) Int. Cl. G06F 3/12

(52) U.S. Cl. 358/1.13

(57) ABSTRACT

According to an embodiment, an image forming apparatus includes a user information acquiring unit, a scanner, a display, a processing unit, and a printer. The user information acquiring unit acquires user information. The scanner scans a document image added with a tracking ID. The display displays a list of selectable destinations according to the tracking ID extracted from the image scanned by the scanner and the user information acquired by the user information acquiring unit. The processing unit acquires the tracking ID added to a print for destinations selected out of the list of the destinations displayed on the display and acquires print data obtained by combining the acquired tracking ID and the document image scanned by the scanner. The printer prints the print data acquired by the processing unit on a recording medium.

### CROSS-REFERENCE TO RELATED APPLICATIONS

This application is based upon and claims the benefit of priority from U.S. Provisional Application No. 61/256,538 filed on Oct. 30, 2009, the entire contents of which are incorporated herein by reference.

### FIELD

Embodiments described herein relate generally to an image forming apparatus, a document managing system, and a document managing method.

### BACKGROUND

Tracking information such as information concerning who access an electronic file can be managed for the electronic file. However, since a sheet having an image of the electronic file printed thereon can be easily copied, it is difficult to manage the sheet. In the past, there is a technique for limiting copying with hidden character printing or the like. However, in the technique of the hidden character printing, it is difficult to manage tracking information indicating destinations and the like of a copied sheet.

### BRIEF DESCRIPTION OF THE DRAWINGS

FIG. 1 is a schematic diagram of an example of the configuration of a document managing system;

FIG. 2 is a block diagram of an example of the configurations of control systems of a digital multifunction peripheral and a server;

FIG. 3 is a diagram of a printing example of an image added with a tracking ID;

FIG. 4 is a diagram of an example of the structure of a user management table;

FIG. 5 is a diagram of an example of the structure of a document management table;

FIG. 6 is a diagram of an example of the structure of a tracking management table;

FIG. 7 is a diagram of an example of the structure of an operation management table;

FIG. 8 is a flowchart for explaining an example of processing of a copying operation in the digital multifunction peripheral;

FIG. 9 is a flowchart for explaining the example of the processing of the copying operation in the digital multifunction peripheral;

FIG. 10 is a diagram of an example of display of a scan instruction screen;

FIG. 11 is a diagram of an example of display of a destination selection screen;

FIG. 12 is a diagram of an example of display of an operation selection screen;

FIG. 13 is a diagram of an example of display of an in-printing screen;

FIG. 14 is a diagram of an example of a management ledger;

FIG. 15 is a diagram of an example of display of a confirmation screen (a print end screen); and

FIG. 16 is a flowchart for explaining an example of the operation of the server.

### DETAILED DESCRIPTION

In general, according to an embodiment, an image forming apparatus includes a user information acquiring unit, a scanner, a display, a processing unit, and a printer. The user information acquiring unit acquires user information. The scanner scans a document image added with a tracking ID. The display displays a list of selectable destinations according to the tracking ID extracted from the image scanned by the scanner and the user information acquired by the user information acquiring unit. The processing unit acquires the tracking ID added to a print for destinations selected out of the list of the destinations displayed on the display and acquires print data obtained by combining the acquired tracking ID and the document image scanned by the scanner. The printer prints the print data acquired by the processing unit on a recording medium.

Embodiments are explained in detail below with reference to the accompanying drawings.

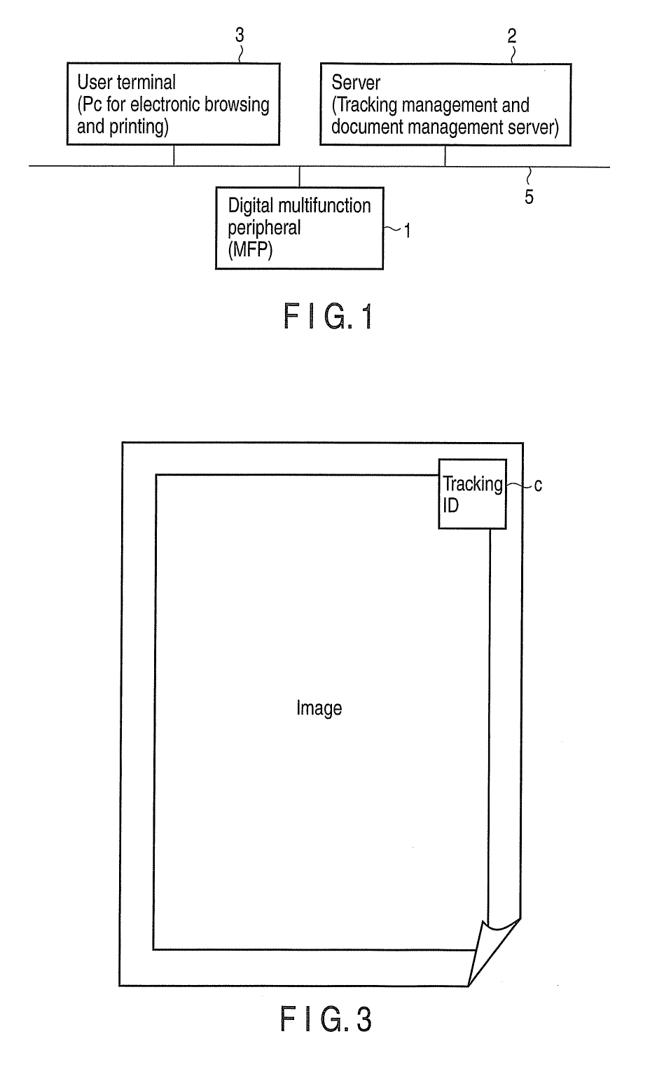

FIG. 1 is a schematic diagram of an example of the configuration of a document managing system.

As shown in FIG. 1, the document managing system includes a digital multifunction peripheral (MFP) 1, a server 2, and a user terminal 3. In the document managing system, the digital multifunction peripheral 1, the server 2, and the user terminal 3 are connected via a local area network 5.

The digital multifunction peripheral 1 functions as an image forming apparatus (a printing apparatus) and an image reading apparatus. The digital multifunction peripheral 1 has a scanner function, a printer function, a network communication function, and the like. The digital multifunction peripheral 1 has a communication function of performing data communication with the apparatuses (the server 2 and the user terminal 3) via the local area network 5. For example, the digital multifunction peripheral 1 as a network printer executes print processing requested from the user terminal 3.

The server 2 is a server computer. The server 2 has a function of performing data communication with the apparatuses via the local area network 5. The server 2 has functions of a document managing server configured to manage documents, a tracking managing server configured to manage tracking information for tracking a sheet having an image printed thereon, and a user managing server configured to manage user information. The server 2 may have a function of a print server configured to manage print jobs requested from the apparatuses such as the user terminal 3.

The user terminal 3 is a terminal apparatus used by a user. The user terminal 3 has a communication function for performing data communication with the apparatuses via the local area network 5. The user terminal 3 only has to be an apparatus that can perform data communication via the local area network 5. For example, the user terminal 3 may be a personal computer or may be a portable terminal apparatus. The local area network 5 may be realized by radio communication.

The configuration of the digital multifunction peripheral 1 is explained below.

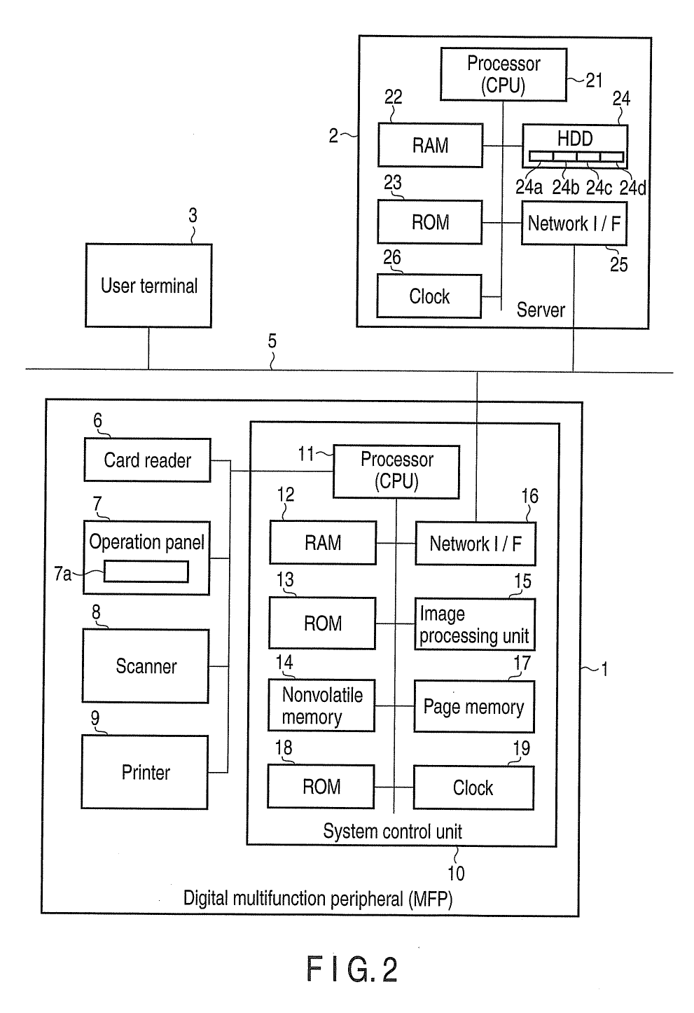

FIG. 2 is a block diagram of an example of the configurations of the digital multifunction peripheral 1 and the server 2.

As shown in FIG. 2, the digital multifunction peripheral 1 includes a card reader 6, an operation panel 7, a scanner (an image reading unit) 8, a printer (an image forming unit) 9, and a system control unit 10. The digital multifunction peripheral 1 includes various external interfaces for inputting and outputting data. The digital multifunction peripheral 1 functions as a copying machine, a scanner, a printer, or a network communication machine.

The card reader 6 reads user information from a storage medium having the user information stored therein. For example, the card reader 6 may be an IC card reader configured to read user information from an IC card carried by the user or may be a tag reader configured to read user information from an IC tag carried by the user.

The operation panel 7 is a user interface. The operation panel 7 includes, for example, various operation buttons and a display unit 7a incorporating a touch panel 7b. The operation panel 7 functions as an operation unit for the user to input an operation instruction and a display unit configured to display guidance and the like for the user.

The scanner 8 reads an image on a document surface as color image data or monochrome image data. The scanner 8 optically scans the document surface to thereby convert the image on the document surface into image data. The scanner 8 includes a scanning mechanism, a photoelectric conversion unit, and a document feeder (ADF).

The printer 9 forms a color image or a monochrome image on a sheet. For example, the printer 9 is an image forming apparatus of an electrophotographic system. The printer 9 of the electrophotographic system includes a sheet storing unit, a conveying mechanism, an exposing device, a photoconductive drum, a developing device, a transfer belt, a transfer device, and a fixing device. However, the printer 9 is not limited to the electrophotographic system. The printer 9 may perform image formation according to a printing system such as an ink jet system or a thermal transfer system.

The configuration of a control system of the digital multifunction peripheral 1 is explained below.

The system control unit 10 collectively controls the units of the digital multifunction peripheral 1. For example, in the digital multifunction peripheral 1, the system control unit 10 controls the card reader 6, the operation panel 7, the scanner 8, and the printer 9. As shown in FIG. 2, the system control unit 10 includes a processor (CPU) 11, a random access memory (RAM) 12, a read only memory (ROM) 13, a nonvolatile memory 14, an image processing unit 15, a network interface 16, a page memory 17, a hard disk drive (HDD) 18, a clock 19 and the like.

The processor 11 is, for example, a CPU. The processor 11 executes control programs stored in the ROM 13, the nonvolatile memory 14, or the HDD 18 to thereby realize various processing functions. The RAM 12 is a main memory functioning as a working memory. The ROM 13 stores a control program, control data, and the like for managing the operation of the digital multifunction peripheral 1. The nonvolatile memory 14 is a rewritable nonvolatile memory. The nonvolatile memory 14 stores control programs and control data for realizing various processing functions. For example, the nonvolatile memory 14 stores setting information.

The image processing unit 15 processes image data read by the scanner 8 or image data received via a network. The network interface 16 is an interface for performing communication with an external apparatus via the local area network 5. The page memory 17 is a memory having a storage area on which image data for at least one page is expanded. The HDD 18 is a large-capacity memory for data storage. The HDD 18 accumulates, for example, image data set as a printing target. The clock 19 counts the present date and time.

The configuration of the server 2 is explained below.

As shown in FIG. 2, the server 2 includes a processor (CPU) 21, a RAM 22, a ROM 23, a HDD 24, a network interface (I/F) 25, and a clock 26.

The processor 21 is, for example, a CPU. The processor 21 manages control of the entire server 2. The processor 21 executes computer programs stored in the ROM 23 or the HDD 24 to thereby realize various processing functions. For example, the processor 21 has a document managing function, a tracking managing function, and a user authentication function. The processor 21 realizes these functions by executing the computer programs. For example, as the document managing function, the processor 21 manages a document including an image set as a printing target by the digital multifunction peripheral 1. As the tracking managing function, the processor 21 manages tracking information for tracking a sheet having an image printed thereon. As the user authentication function, the processor 21 collates user information (e.g., a user ID and a password) received from the digital multifunction peripheral 1 and data for user authentication stored in the HDD 24 to thereby determine whether user authentication is successful.

The RAM 22 is a working memory. The RAM 22 temporarily stores, for example, data for work. The ROM 23 stores a control program, control data, and the like for managing a basic operation of the server 2. The network interface 25 is an interface for performing data communication with the apparatuses in the local area network 5. The clock 26 counts the present date and time.

The HDD 24 is a storage device for data storage. The HDD 24 stores information for managing an image set as a printing target in the entire system. The HDD 24 includes a user management table 24a, a document management table 24b, a tracking management table 24c, and an operation management table 24d. The user management table 24a stores user information. The document management table 24b stores information concerning a document (an original document) set as a printing target. The tracking management table 24c stores tracking information for tracking a sheet having an image printed thereon. The operation management table 24d stores information such as operable condition for determining an executable operation for each user.

The digital multifunction peripheral 1 may include a part or all of the functions of the server 2. For example, the processor 11 of the digital multifunction peripheral 1 may realize the user authentication function, the document managing function, the tracking managing function, or an operation determining function. The tables 24a to 24d may be provided in the HDD 18 of the digital multifunction peripheral 1 or may be provided in an apparatus such as another server apparatus connected to the network 5.

Management of a sheet having a document (an image) printed thereon is explained below.

The document managing system manages a sheet having an image printed thereon. The document managing system manages generation number of an image printed on a sheet (e.g., the number of times of image formation). The document managing system can limit printing of the image according to information on the generation. The document managing system issues a tracking ID as identification information for tracking a sheet having one image copied or printed thereon. The tracking ID is, for example, information that can be converted into code information such as a two-dimensional barcode. The document managing system prints, together with an image for print, information such as a barcode indicating the tracking ID. The document managing system identifies and manages the sheet according to the tracking ID obtained from the barcode printed on the sheet.

FIG. 3 is a diagram of an example in which an image and a barcode indicating a tracking ID are printed on a sheet.

In the example shown in FIG. 3, information indicating a tracking ID as identification information is printed on a sheet together with an image of an original document. The information indicating the tracking ID only has to be information with which a processor can recognize the tracking ID from a scanned image. For example, the information indicating the tracking ID printed on the sheet is a character, a one-dimensional barcode, a two-dimensional barcode, a QR code, a color code, a hidden character, an ultraviolet ink, or the like that can be optically recognized (OCR).

In the document managing system, the server 2 issues a tracking ID for each image (document image) that should be printed on a sheet. The server 2 converts information including the issued tracking ID into a barcode C. The server 2 supplies, to the digital multifunction peripheral 1, the barcode C associated with the document image that should be printed. The server 2 stores information such as a document name, a user (owner) name, an expiration date, a generation number (the number of times of print), and the like in the tracking management table 24c in association with the issued tracking ID.

The digital multifunction peripheral 1 creates print data obtained by adding the barcode C indicating the tracking ID issued by the server 2 to image data that should be printed. For example, the digital multifunction peripheral 1 creates print data in which the barcode C is arranged in a reference position (in the example shown in FIG. 3, upper right) on a sheet. The print data may be created by the server 2 and transmitted to the digital multifunction peripheral 1. If the digital multifunction peripheral 1 obtains the print data, the digital multifunction peripheral 1 prints the print data on the sheet with the printer 9.

The user management table 24a is explained below.

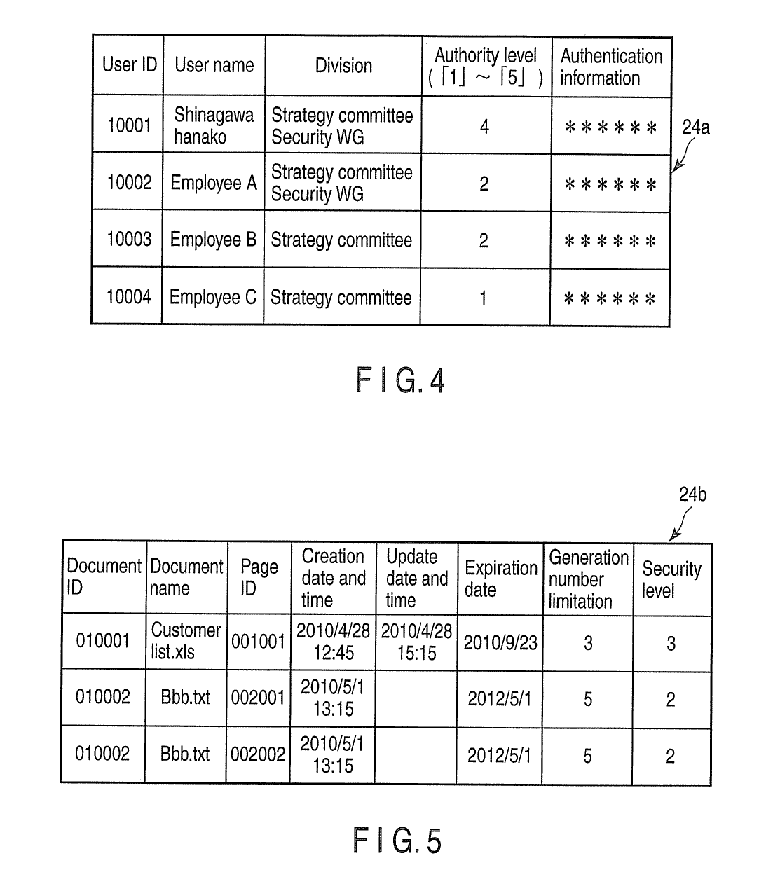

FIG. 4 is a diagram of an example of the structure of the user management table 24a.

In the example of the structure shown in FIG. 4, the user management table 24a stores a user ID, a user name, a division, an authority level, and authentication information. The user ID is identification information for identifying a user. The authority level indicates authority given to the user. In the example shown in FIG. 4, as the authority level of each user, there are levels “1 (lowest)” to “5 (highest)” in order from the lowest level. Any one of the levels is allocated to the user. The authentication information is information for authenticating the user, for example, a password.

The document management table 24b is explained below.

FIG. 5 is a diagram of an example of the structure of the document management table 24b.

In the example shown in FIG. 5, the document management table 24b stores a document ID, a document name (a file name), a page ID, creation date and time, update date and time, an expiration date, limitation on a generation number, and a security level in association with one another. The document ID is document identification information for identifying a document. The document for which the document ID is issued includes one or plural pages. If a new document is printed, the server 2 issues a document ID for the entire document. The document name (the file name) is a name as electronic data of the document. The document name may be stored separately from the file name.

The page ID is identification information for identifying an image of each page included in the document (each image set as a printing target). The page ID may be information to be completely unique or may be information to be unique if combined with the document ID in the document managing system. If a new document is printed, the server 2 issues a page ID for each page of the document and registers the page ID in the document management table 24b. The creation date and time is information indicating creation date and time of the page. The update date and time is information indicating update date and time of the page.

The expiration date is information indicating an expiration date set for each page. The limitation on a generation number is information indicating a limited value of the number of times of print set for each page. The security level is information indicating security setting for an image of each page. The security level is information for determining an executable operation for the image of each page. For example, the expiration date, the limitation on a generation number, and the security level may be set by a user who prints a document first or an administrator or may be set according to attribute information or the like of the document.

The tracking management table 24c is explained below.

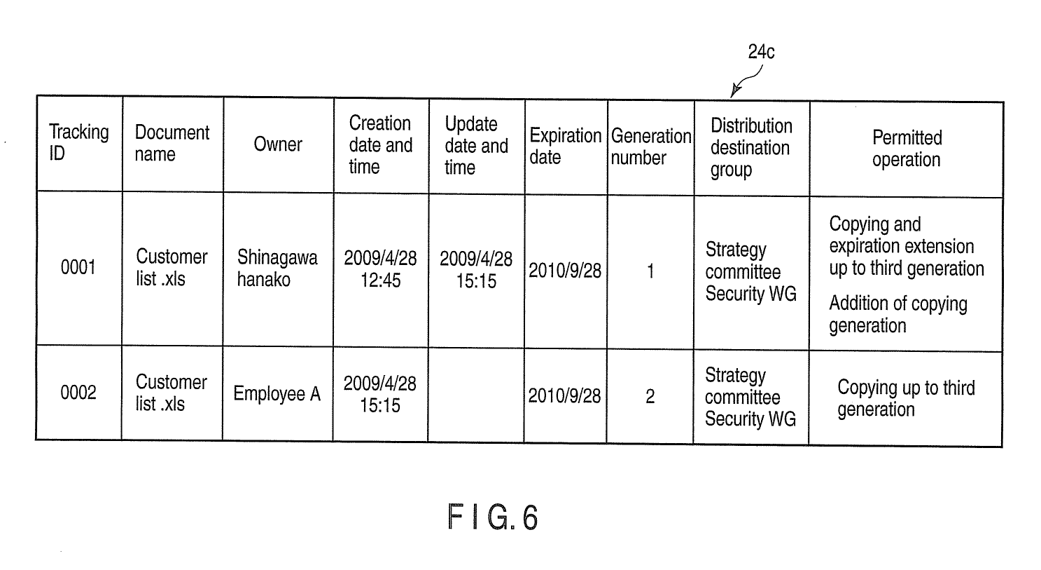

FIG. 6 is a diagram of an example of the structure of the tracking management table 24c.

In the example shown in FIG. 6, the tracking management table 24c stores a tracking ID, a document name, a owner, creation date and time, update date and time, an expiration date, a generation number, a destination group, and a permitted operation in association with one another. The tracking ID is identification information for identifying a sheet having an image printed thereon.

The document name (a file name) is information indicating a printed document. The tracking management table 24c may store the file name separately from the document name. The owner is information indicating a user who owns a sheet having the document or a page printed thereon. The tracking management table 24c may store information indicating a user who executed the printing of the document or the page. The creation date and time is information indicating date and time of the printed document or page. The update date and time is information indicating update date and time of the printed document or page.

The expiration date is information indicating an expiration date for a sheet having each page printed thereon (a sheet identified by the tracking ID). The generation number is information indicating a generation number of the sheet having the page printed thereon. The generation number is the number of times the page is printed. For example, if an original is printed, the generation number is “0”. If a sheet having the original (an image with the generation number “0”) printed thereon is copied, the generation number is “1”. A sheet having the printed image with the generation number “1” printed thereon is further copied, the generation number is “2”. In this way, the generation number is a cumulative number of times of printing for the image printed by the print processing. The destination group is information indicating a group (a division) to which a user (an owner) at a destination belongs. The permitted operation is information indicating an executable operation determined according to a security level of the printed document and an authority level of the user (the owner) at the destination.

The operation management table 24d is explained below.

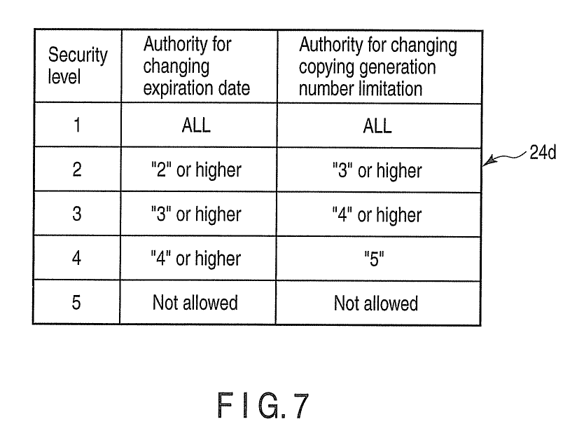

FIG. 7 is a diagram of an example of the structure of the operation management table 24d.

In the example shown in FIG. 7, the operation management table 24d stores a security level, an authority for enabling expiration extension, and an authority for enabling generation addition in association with one another. The operation management table 24d shown in FIG. 7 stores, for each security level, an authority level of a user as a condition under which various operations are executable. The operation management table 24d stores, for each security level, information concerning operations having different conditions under which operations are executable. In the example of the operation management table shown in FIG. 7, an executable authority level for each security level is stored concerning a change of an expiration date and a change of copying generation number limitation, which are operations having, for each security level, different authority levels as conditions under which operations are executable.

As the security level, for example, a level “1 (lowest)” to a level “5 (highest)” are set according to levels of security. The security level is information corresponding to a level of security set for each page (each image set as a printing target) of each document. The “authority for enabling expiration extension” indicates, for each security level, an authority of a user who can change (extend or reduce) an expiration date for a sheet having an image copied (printed) thereon. The “authority for enabling generation addition” indicates an authority of a user who can change (add or reduce) generation number limitation for a sheet having the image with the security level is copied (printed) thereon.

A copying operation in the document managing system is explained below.

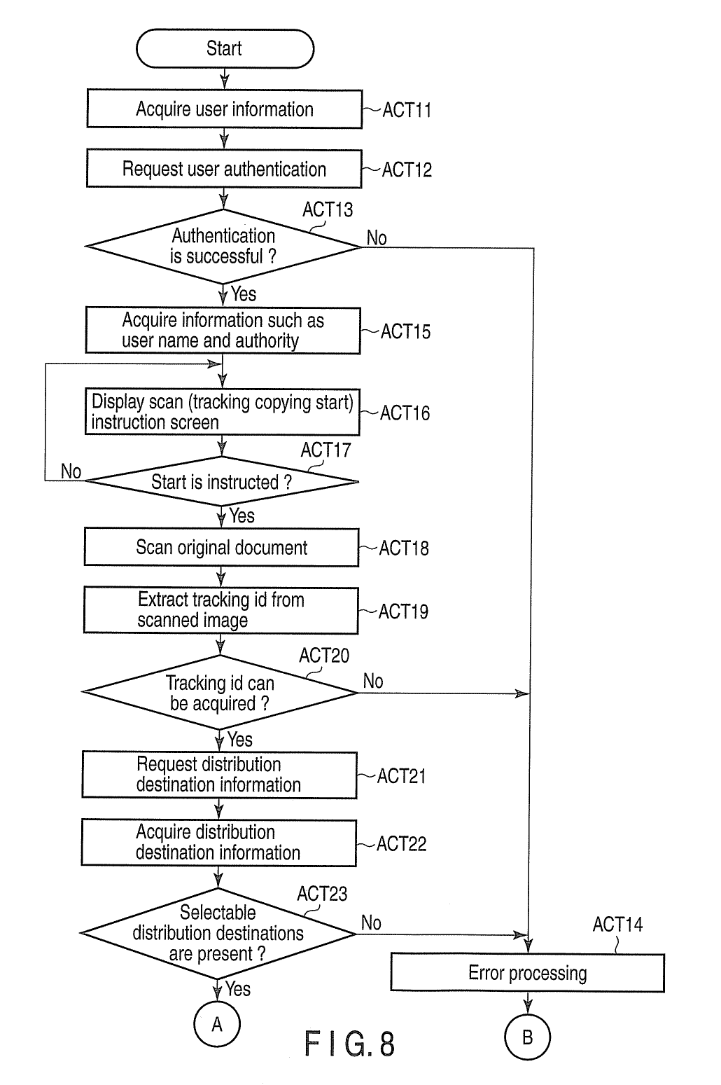

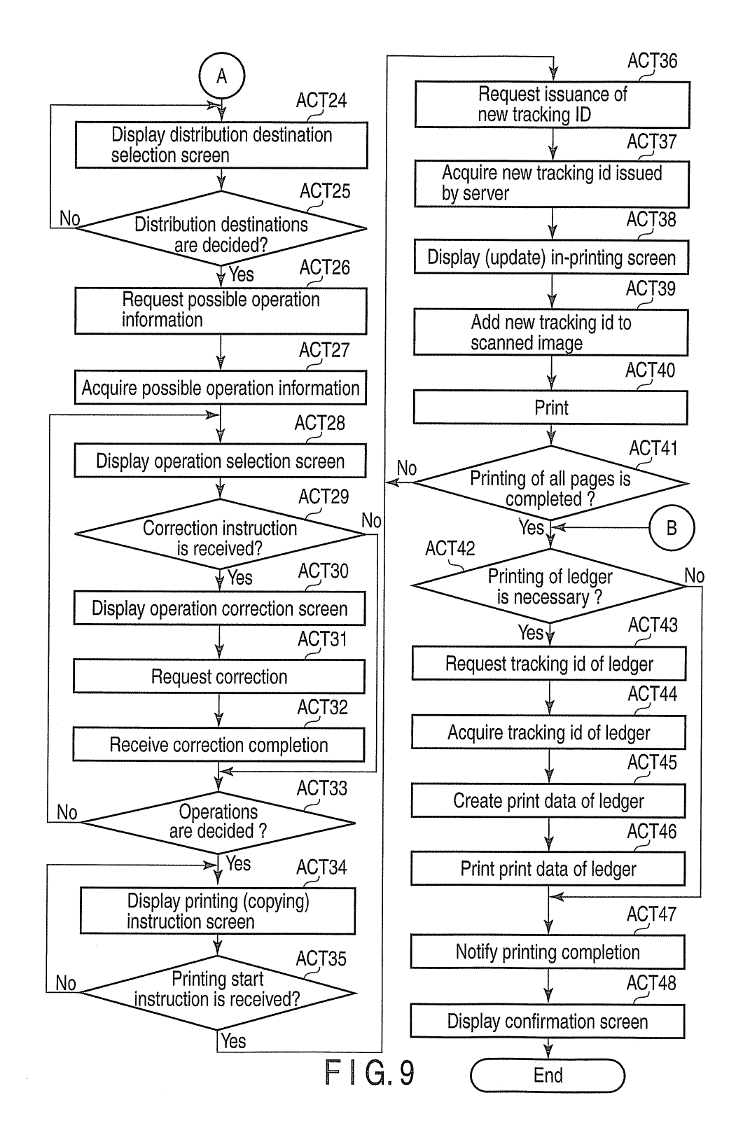

FIGS. 8 and 9 are flowcharts for explaining an example of a copying operation in the digital multifunction peripheral 1.

If tracking copying is executed, the processor 11 acquires user information in order to perform user authentication (ACT 11). For example, the processor 11 acquires, with the card reader 6, user information from an IC card carried by a user. The processor 11 may acquire user information such as a user ID and a password input by the user on the operation panel 7. After acquiring the user information, the processor 11 requests the server 2 to perform user authentication (ACT 12). For example, the processor 11 transmits a user authentication request to the server 2 together with the acquired user information. The server 2 performs user authentication according to the user information received from the digital multifunction peripheral 1. The server 2 returns a result of the user authentication to the digital multifunction peripheral 1.

If the processor 11 of the digital multifunction peripheral 1 receives the user authentication result from the server 2, the processor 11 determines whether the user authentication is successful (ACT 13). If the processor 11 determines that the user authentication is unsuccessful (NO in ACT 13), the processor 11 performs error processing (ACT 14). For example, as the error processing performed if the user authentication is unsuccessful, the processor 11 displays, on the display unit 7a, indication that the user authentication is unsuccessful.

If the processor 11 determines that the user authentication is successful (YES in ACT 13), the processor 11 acquires, from the server 2, a user name and authority information of the user obtained as the user authentication result (ACT 15). After acquiring the user name and the authority information of the user who succeeds in the authentication, the processor 11 displays, on the display unit 7a, a scan instruction screen for instructing the start of tracking copying (scanning) (ACT 16).

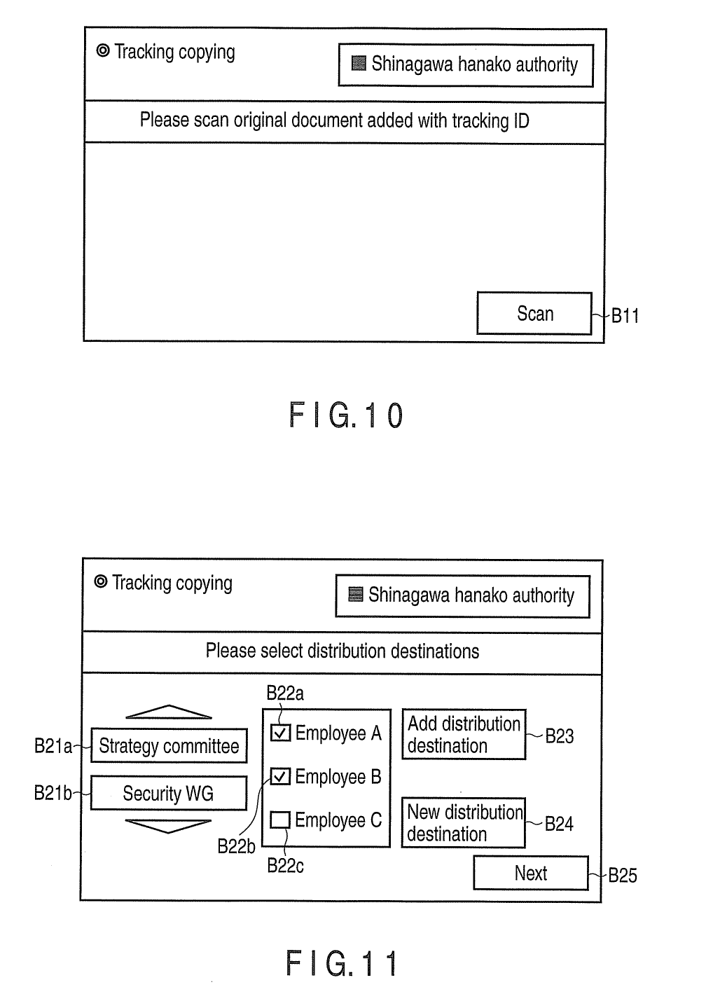

FIG. 10 is a diagram of an example of display of the scan instruction screen. On the scan instruction screen displayed in FIG. 10, the processor 11 displays function guidance, a user name, authority of a user, operation guidance, a scan button B11, and the like on the display unit 7a. For example, the processor 11 displays, as the function guidance, an icon indicating that an operation mode is a tracking copying function and guidance by characters. In the example shown in FIG. 10, the processor 11 displays “* tracking copy” as the function guidance. “*” is the icon indicating the tracking copying function. The indication of “tracking copy” is the guidance by characters indicating that the operation mode is the tracking copying.

The indication of “+Shinagawa Hanako” in the example shown in FIG. 10 is an icon “+” allocated to the user and the user name “Shinagawa Hanako”. For example, the icon allocated to the user may be a reduced image of a face photograph of the user. The indication of “authority” in the example shown in FIG. 10 indicates a display area for displaying the authority of the user. Examples of the authority of the user include possibility of printing in color, possibility of printing without a tracking ID, and possibility of printing without a watermark. An authority level of the user may be displayed.

The indication of “please scan an original document added with a tracking ID” in the example shown in FIG. 10 is operation guidance for the user. In the display example shown in FIG. 10, the processor 11 displays the scan button B11 for instructing the start of scanning (copying). The scan button B11 can be selected by the touch panel 7b. The start of scanning may be instructed by a hard key (e.g., a start key) or the like provided on the operation panel 7.

If the user detects that the scan instruction is input (YES in ACT 17), the processor 11 executes scanning of an original document with the scanner 8 (ACT 18). The processor 11 stores a scanned image of the original document in the page memory 17 or the HDD 18. After scanning the original document, the processor 11 extracts a tracking ID from the scanned image of the original document (ACT 19). For example, the tracking ID is printed on a part of the surface of the original document together with an image. In the example shown in FIG. 3, the tracking ID is converted into a barcode and printed on the upper right of the original document. An original document as a sheet printed by the document managing system has a tracking ID converted into an image of a barcode or the like. For example, the processor 11 extracts the barcode image indicating the tracking ID from the scanned image and decodes the extracted barcode image to thereby acquire the tracking ID.

If the tracking ID is not obtained from the scanned image of the original document (NO in ACT 20), the processor 11 performs error processing (ACT 14). For example, as the error processing performed if the tracking ID is not obtained from the original document, the processor 11 displays, on the display unit 7a, error guidance indicating that the tracking ID cannot be confirmed. The processor 11 may display, on the display unit 7a, guidance for instructing the user to check the original document and perform scanning again.

If the tracking ID can be obtained from the scanned image of the original document (YES in ACT 20), the processor 11 requests the server 2 to transmit destination information determined from the tracking ID (ACT 21). For example, the processor 11 transmits the user authentication information obtained by the user authentication and the tracking ID obtained from the original document to the server 2 together with a transmission request for destination information. The serve 2 creates a list of destinations according to the user authentication information and the tracking ID received from the digital multifunction peripheral 1. The server 2 transmits destination information including the created list of destinations to the digital multifunction peripheral 1.

If the processor 11 of the digital multifunction peripheral 1 receives the destination information from the server 2 (ACT 22), the processor 11 determines whether selectable (valid) destinations are present (ACT 23). If the processor 11 determines that no selectable destination is present (NO in ACT 23), the processor 11 performs error processing (ACT 14). For example, as the error processing performed if no selectable destination is present, the processor 11 displays, on the display unit 7a, error guidance indicating that no valid destination is present. If the processor 11 determines that selectable destinations are present (YES in ACT 23), the processor 11 displays, on the display unit 7a, a destination selection screen for selecting a destination (ACT 24).

FIG. 11 is,a diagram of an example of display of the destination selection screen. In the example shown in FIG. 11, the processor 11 displays, as the destination selection screen, function guidance, a user name, authority of a user, operation guidance, group selection buttons B21 (B21a and B21b), a destination list, a destination addition button B23, a new destination button B24, a “next” button B25, and the like on the display unit 7a. The buttons are icons selectable by the user on the touch panel 7b. For example, in the same manner as shown in FIG. 10, the processor 11 displays the icon indicating that the operation mode is the tracking copying function and guidance by characters as the function guidance. In the same manner as shown in FIG. 10, the processor 11 also displays the user name and the user authority “* Shinagawa Hanako Authority”. The processor 11 displays guidance “please select destinations” as the operation guidance.

The group selection buttons B21 are buttons for selecting groups as destinations. The group selection buttons B21 are icons indicating groups of selectable destinations. In the display example shown in FIG. 11, the processor 11 displays, as the group selection buttons B21, an icon B21a indicating “strategy committee” and an icon B21b indicating “security WG”. If all the buttons of selectable groups cannot be displayed in one screen, the processor 11 may display up and down buttons and display buttons of other groups according to input of the up and down buttons. The button of a selected group is displayed in a display state indicating that the button is in a selected state. In the display example shown in FIG. 11, the processor 11 reversely displays the icon B21a indicating “strategy committee” to thereby indicate that “strategy committee” is selected as a destination.

The destination list is a list of users as candidates of destinations. In the destination list of the display example shown in FIG. 11, the processor 11 displays check boxes B22 (B22a, B22b, and B22c) associated with the users as the candidates of destinations. The check boxes B22 are displayed corresponding to the users set as the destinations. Every time the processor 11 detects, with the touch panel 7b, that the user touches the check boxes B22, the processor 11 switches presence or absence of checks in the check boxes B22. The processor 11 sets users checked in the check boxes B22 as destinations. For example, in default, the processor 11 may check the check boxes B22 of all the users to whom copies can be distributed. In this case, the user (an operator) performs operation for removing the checks in the check boxes B22 corresponding to unnecessary destinations. If the destination list cannot be displayed on one screen, the processor 11 displays a scroll bar and switch a display range in the destination list according to an instruction to the scroll bar.

The destination addition button B23 is a button for adding a destination. If the user desires to add a destination in the present copying, the user presses the destination addition button B23. If the destination addition button B23 is pressed, the processor 11 may display a destination search screen for searching for a destination. The processor 11 may add a destination designated by the user on the distribution search screen. Only a user having a specified authority level may be allowed to add a destination. It is also possible that, if the user (operator) has authority of adding a destination, the processor 11 displays the distribution addition button B23 and, if the user (the operator) does not have the authority for adding a destination, the processor 11 does not display the destination button B23.

The new destination button B24 is a button for defining a new destination. In defining a new destination group, the user presses the new destination button B24. If the user presses the new destination button B24, the processor 11 displays a destination registration screen for defining a new destination. For example, the processor 11 registers, as a new destination, a destination group designated by the user on the destination registration screen. The new destination group may be retrieved from a shared address book prepared in advance. The new destination group may be retrieved from a shared address book prepared exclusively for the document managing system or may be retrieved from an address book for each individual. On the display unit 7a, the shared address book and the address book for each individual may be switched and displayed or may be displayed together.

Only a user having a specified authority level may be allowed to execute the definition of a new destination. It is also possible that, if the user (the operator) has authority for defining a new destination, the processor 11 displays the new destination button and, if the user (the operator) does not have the authority for defining a new destination, the processor 11 does not display the new destination button.

The “next” button B25 is a button for instructing the user to shift to the next operation. The user who ended the selection of destinations on the destination selection screen presses the “next” button B25. If the user presses the “next” button B25, the processor 11 decides the destinations and shifts to the next operation.

If the user presses the “next” button B25 on the destination selection screen (YES in ACT 25), the processor 11 requests the server 2 to transmit possible operation information indicating operations executable in the destinations (ACT 26). For example, the processor 11 transmits information indicating the selected destinations, the user authentication information obtained by the user authentication, and the tracking ID obtained from the original document to the server 2 together with the transmission request for the possible operation information. The server 2 creates a list of information indicating operations executable in the destinations according to the destinations, the user authentication information, and the tracking ID received from the digital multifunction peripheral 1. The server 2 transmits possible operation information including the created list of information to the digital multifunction peripheral 1. Consequently, the digital multifunction peripheral 1 acquires the possible operation information from the server 2 (ACT 27).

It is also possible not to detect a destination in which executable operation information is not present as the destination included in the destination information. In this case, the destination in which executable operation information is not present is not displayed in the destination list. If the user selects, as a destination, the destination in which executable operation information is not present, the user needs to explicitly add the destination in which executable operation information is not present as a destination using the destination addition button B23 or the new destination button B24. A valid selectable operation is not present for the added destination. Candidates of operations are not displayed in an operation list for the destination in which executable operation information is not present. If the user selects an operation for the destination in which executable operation information is not present, the user needs to explicitly designate and add the operation using the operation addition button B34 or the new operation button B35.

If the processor 11 of the multifunction peripheral 1 receives the possible operation information from the server 2 (ACT 27), the processor 11 displays, on the display unit 7a, an operation selection screen for selecting operations in the destinations (ACT 28). The user selects, on the operation selection screen displayed on the display unit 7a, desired operation from a list of operation for each of the destinations. The user can determine executable operations for the destinations according to a security level of an image to be printed and authority levels of the destinations referring to, for example, the operation management table.

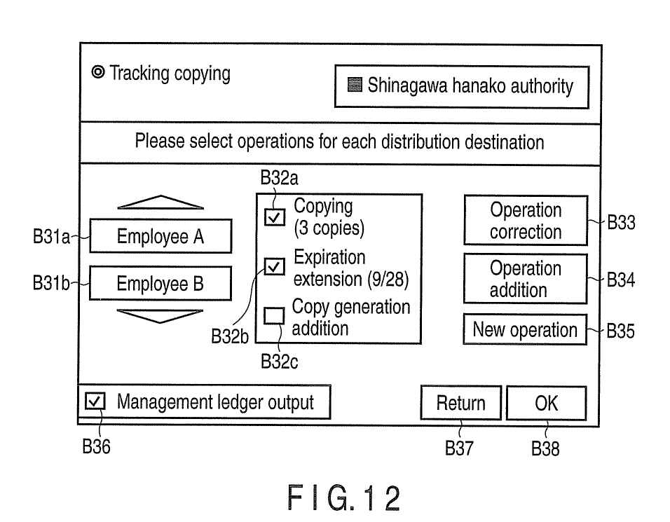

FIG. 12 is a diagram of an example of display of the operation selection screen.

In the example shown in FIG. 12, the processor 11 displays, as the operation selection screen for setting operations for each of the destinations, function guidance, a user name, authority of a user, operation guidance, destination selection buttons B31 (B31a and B31b), an operation list, an operation correction button B33, an operation addition button B34, a new operation button B35, a ledger check box B36, a “return” button B37, an OK button B38, and the like on the display unit 7a. The buttons and check boxes are icons that the user can select with the touch panel 7b. In the same manner as shown in FIGS. 10 and 11, the processor 11 displays function guidance, a user name, and user authority as the function guidance. The processor 11 displays guidance “please select operations for each of the destinations” as the operation guidance.

The destination selection buttons B31 are buttons for selecting destinations for which operations are set. The destination selection buttons B31 are icons indicating selectable destinations. In the display example shown in FIG. 12, the processor 11 displays the icon B31a indicating “employee A” and the icon B31b indicating “employee B” as the destination selection buttons B31. If all the destination selection buttons B31 cannot be displayed on one screen, the processor 11 may display up and down buttons and switch, according to input of the up and down buttons, a destination button to be displayed. The selected destination button is displayed in a display state indicating that the destination button is selected. In the display example shown in FIG. 12, the processor 11 reversely displays the icon B31a indicating “employee A” to thereby indicate that “employee A” is selected as a destination.

The operation list is a list of operations that can be set for the selected destination. In the operation list of the display example shown in FIG. 12, the processor 11 displays check boxes B32 (B32a, B32b, and B33b) associated with candidates of operations. The check boxes B32 indicate whether operations corresponding thereto are executed. Every time the processor 11 detects, with touch panel 7b, that the user touches the check boxes B32, the processor 11 switches presence or absence of checks in the check boxes B32. For example, in default, the processor 11 may check the check boxes B32 for all operations that can be set. In this case, the user (the operator) only has to perform operation for removing checks in the check boxes B32 corresponding to unnecessary operations.

If the operation list cannot be displayed on one screen, the processor 11 may display a scroll bar and switch a display range in the operation list according to an instruction to the scroll bar. The processor 11 may display incidental information together with operation contents in the operation list. For example, if printing such as copying is performed, the processor 21 may display the number of prints as the incidental information. For example, in the example shown in FIG. 12, the processor 11 displays “copy” as operation content and displays “(three)” as the remaining number of copies. In the example shown in FIG. 12, the processor 11 displays “expiration extension” as operation content and displays “(September 28)” as the present expiration date.

The operation correction button B33 is a button for correcting an operation. If the user desires to correct operation content, the user presses the operation correction button B33. If the user presses the operation correction button B33, the processor 11 displays an operation correction screen for correcting operation content selected by the user. The processor 11 corrects the operation according to correction content designated by the user on the operation correction screen. For example, if the user desires to take two copies for the employee A, the user presses the operation correction button B33. If the user presses the operation correction button B33, the processor 11 displays the operation correction screen. On the operation correction screen, the user can correct the number of copies to two as incidental information of the copying operation. If the correction content is within a range of conditions under which the operations are executable, the processor 11 performs operation correction processing.

Only a user having a specified authority level can instruct correction of an operation. For example, if a user having authority for changing a copying generation number presses the operation correction button B33, the processor 11 performs correction of the copying generation number according to an instruction of the user. If a user having authority for changing an expiration date presses the operation correction button B33, the processor 11 performs correction of the expiration date according to an instruction of the user.

Only a user having a specified authority level may be allowed to execute operation correction itself. It is also possible that, if the user (the operator) has authority for correcting an operation, the processor 11 displays the operation correction button and, if the user does not have the authority for correcting an operation, the processor 11 does not display the operation correction button.

The operation addition button B34 is a button for adding an operation. If the user desires to add an operation, the user presses the operation addition button B34. If the user presses the operation addition button B34, the processor 11 may display an operation search screen for searching for an operation. The processor 11 may add an operation designated by the user on the operation search screen. Only a user having a specified authority level may be allowed to execute the addition of an operation. In other words, it is also possible that, if the user (the operator) has authority for adding a destination, the processor 11 displays the operation addition button B34 and, if the user does not have the authority for adding a destination, the processor 11 does not display the operation addition button B34.

The new operation button B35 is a button for defining a new operation. If the user (the operator) defines a new operation, the user presses the new operation button B35. If the user presses the new operation button B35, the processor 11 displays an operation registration screen for defining a new operation. For example, the processor 11 registers, as a new operation with an operation name designated by the user, an operation defined by the user on the operation registration screen.

The new operation can be defined by a management tool program for the document managing system executed by the processor 11. For example, the processor 11 can define behavior, which is performed if the operation is selected, by executing the management tool program or can define the operation as attribute information of mere metadata in the server 2. The new operation defined in this way may be allowed to be set as a target of operation addition and selected (displayed) on the operation search screen.

Only a user having a specified authority level may be allowed to execute the definition of a new operation. It is also possible that, if the user (the operator) has authority for defining a new destination, the processor 11 displays the new operation button B35 and, if the user (the operator) does not have the authority for defining a new destination, the processor 11 does not display the new operation button B35.

The ledger check box B36 is a check box for setting whether a management ledger is output. The management ledger is a sheet on which information related to the copying processing is printed. If the ledger check box B36 is checked, the processor 11 prints the management ledger. For example, the processor 11 prints, on the management ledger, a tracking ID of the ledger itself, attribute information (e.g., a tracking ID) of an image set as a copying target, attribute information of copying (an executer of copying, copying date and time, etc.), destination attribute information (an owner name) of each destination, a tracking ID of a printed sheet, and a writing area for a discarding (collection) date.

The return button B37 is a button for instructing the user to return to the preceding operation. For example, if the user desires to return to the destination selecting operation, the user presses the return button B37. If the user presses the return button B37, the processor 11 cancels setting of an operation and shifts to the preceding operation (e.g., setting of destinations).

The OK button B38 is a button for instructing the user to complete the operation setting and shift to the next operation. If the user ends the selection of operations for the destinations on the operation selection screen, the user presses the OK button B38. If the user presses the OK button B38, the processor 11 decides the operation setting for the destinations and shifts to the next operation.

If operation correction is instructed on the operation selection screen (YES in ACT 29), the processor 11 displays an operation correction screen for correcting operation content (ACT 30). For example, if a user “Shinagawa Hanako” presses the operation correction button B33 on the operation selection screen shown in FIG. 12, the processor 11 displays, on the display unit 7a, the operation correction screen for correcting an operation with the authority of the user “Shinagawa Hanako”. For example, on the operation correction screen, the processor 11 displays the present number of remaining copies and an expiration date. The processor 11 may change display content of the operation correction screen according to the authority of a user. For example, if an authenticated user has authority for copying generation addition, the processor 11 displays an input space for correction of the remaining number of copies on the operation correction screen. If the authenticated user has authority for expiration date extension, the processor 11 displays an input space for correction of an expiration date on the operation correction screen.

If the user inputs, on the operation correction screen, a correction value for an operation such as a correction value of the remaining number of copies or a correction value of the expiration date, the processor 11 requests the server 2 to correct the operation according to correction content designated by the user (ACT 31). The server 2 that receives the request for operation correction registers the correction content of the operation and transmits notification of completion of the operation correction to the digital multifunction peripheral 1. The processor 11 receives the notification of completion of the operation correction from the server 2 to thereby complete the operation correction (ACT 32).

If completion of the operation setting is instructed (YES in ACT 33), the processor 11 displays, on the display unit 7a, a print instruction screen for instructing the start of printing (copying) (ACT 34). If the user instructs the start of printing on the print instruction screen (YES in ACT 35), the processor 11 requests the server 2 to issue a new tracking ID for an image to be printed on a sheet (ACT 36). For example, the processor 11 transmits a request for issuance of a tracking ID to the server 2 together with information indicating an image for which a new tracking ID is necessary. The server 2 receives the request for issuance for a tracking ID from the digital multifunction peripheral 1 and issues a new tracking ID. The server 2 transmits the issued tracking ID to the digital multifunction peripheral 1 in association with information indicating the image.

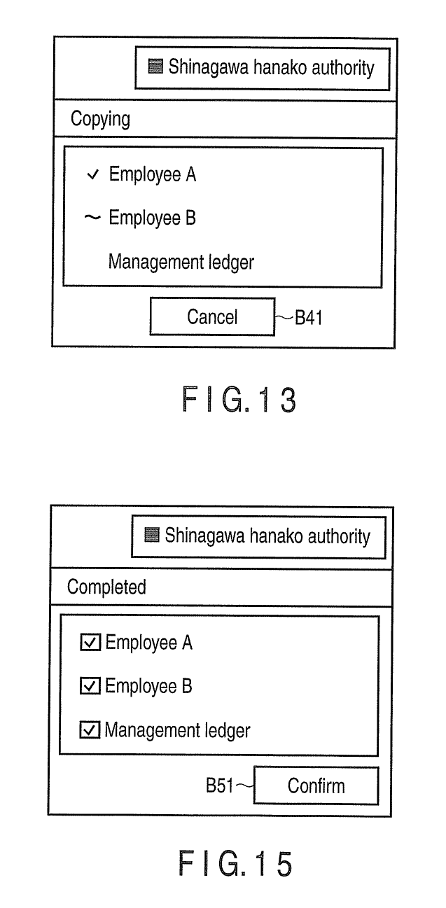

If the processor 11 receives the tracking ID issued by the sever 2 anew, the processor 11 displays an in-printing screen indicating that printing is being performed (ACT 38). For example, the processor 11 displays a state of progress of printing on the in-printing screen. FIG. 13 is a diagram of an example of display of the in-printing screen. In the display example shown in FIG. 13, the processor 11 displays destinations and the management ledger side by side as printing targets. The processor 11 adds, in order, check marks to the printing targets for which printing ends and displays the check marks. In the display example shown in FIG. 13, the processor 11 adds a check mark to the employee A as a first destination and displays the check mark. The processor 11 adds a mark (“˜”) indicating that copying is being performed to the employee B as a second destination and displays the mark. In the display example shown in FIG. 13, the processor 11 also displays a cancel button B41 for the user to instruct the suspension of printing (copying).

If the user presses the cancel button B41, the processor 11 suspends printing (copying) for the destinations. If the printing is suspended, the processor 11 may cancel the printing of the management ledger or may output the management ledger for completed printing (copying). If the copying is suspended, the processor 11 may determine, according to setting by the user or setting contents for documents, whether printing of the management ledger is performed.

If the processor 11 of the digital multifunction peripheral 1 receives the tracking ID issued by the server 2 anew, the processor 11 creates, with the image processing unit 15 or the like, print data in which the new tracking ID is added to the image of the original document (ACT 39). The processor 11 executes printing of the print data with the printer 9 (ACT 40).

If printing for one copy is completed, the processor 11 determines whether printing of all pages is completed (ACT 41). If the processor 11 determines that the printing of all the pages is not completed (NO in ACT 41), the processor 11 returns to ACT 36, issues a tracking ID for the next print image, and continues the print processing. If the processor 11 determines that the printing of all the pages is completed (YES in ACT 41), the processor 11 determines whether printing of the management ledger is necessary (ACT 42).

If the processor 11 determines that the printing of the management ledger is necessary (YES in ACT 42), the processor 11 requests the server 2 to issue a new tracking ID to be printed on the management ledger (ACT 43). For example, the processor 11 prints, on the management ledger, a tracking ID of the management ledger itself, attribute information (e.g., a tracking ID) of an image set as a copying target, attribute information of copying (an executer of copying, date and time of copying, etc.), destination attribute information (an owner name) of each destination, a tracking ID of a printed sheet, a writing area for a discarding (collection) date, and the like. The processor 11 edits the information other than the tracking ID of the management ledger itself and creates an image for printing. In this case, the processor 11 requests the server 2 to issue a new tracking ID added to the management ledger. The server 2 issues a new tracking ID for the management ledger. The server 2 transmits the issued new tracking ID to the digital multifunction peripheral 1.

If the processor 11 of the digital multifunction peripheral 1 acquires the new tracking ID from the server 2 (ACT 44), the processor 11 sets the acquired new tracking ID as a tracking ID of the management ledger and creates print data for management ledger obtained by editing the pieces of information (ACT 45). After obtaining the print data for the management ledger, the processor 11 prints the print data for the management ledger on a sheet (ACT 46). The sheet having the print data for the management ledger printed thereon is the management ledger.

However, the server 2 may create the print data to be printed as the management ledger. In this case, the server 2 receives information necessary for the management ledger from the digital multifunction peripheral 1. The server 2 issues a new tracking ID for the management ledger. The server 2 creates print data of the management ledger according to the information received from the digital multifunction peripheral 1 and the new tracking ID. The server 2 transmits the created print data of the management ledger to the digital multifunction peripheral 1. The digital multifunction peripheral 1 prints, as the management ledger, the print data acquired from the server 2.

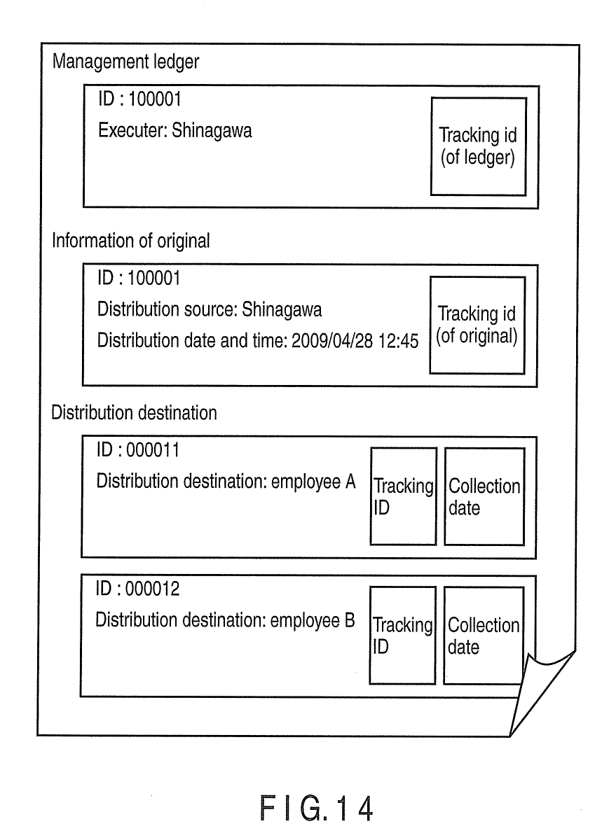

FIG. 14 is a diagram of an example of the management ledger. In the management ledger shown in FIG. 14, information concerning the management ledger itself, information concerning a printed original, information concerning destinations, and the like are printed. As the information concerning the management ledger itself, a tracking ID of the ledger itself, information indicating a user who executed the printing, a barcode obtained by encoding these pieces of information, and the like are printed. As the information concerning the printed original, attribute information (e.g., a tracking ID) of an image set as a copying target, attribute information of copying (an executer of copying, date and time of copying, etc.), a barcode obtained by encoding these pieces of information, and the like are printed. As the information concerning the destinations, attribute information of a destination (a destination name and an owner name), a tracking ID of a printed sheet, a barcode obtained by encoding these pieces of information, a writing area for a collection (discarding) date, and the like are printed for each of the destinations.

A date if the sheet is collected (or discarded) is written in the writing area for a collection (discarding) date. The digital multifunction peripheral 1 may scan, with the scanner 8, the management ledger in which a collection date is written. If the digital multifunction peripheral 1 scans the management ledger in which the collection date is written, the digital multifunction peripheral 1 notifies the server 2 of a date if the sheet is collected, a tracking ID of the collected sheet, and the like. Consequently, the server 2 can manage the collected (discarded) sheet. The digital multifunction peripheral 1 may print, concerning a document (a destination) for which discarding or collection is confirmed, information including a collection date and the like (e.g., information such as a collecting method, a collection place, and a collection equipment name) on the management ledger again.

Further, the digital multifunction peripheral 1 may scan, with the scanner 8, a sheet (a sheet having a tracking ID printed thereon) itself to be discarded. If the sheet to be discarded is scanned, the digital multifunction peripheral 1 acquires the tracking ID from the scanned image and notifies the server 2 of the tracking ID. Consequently, the server 2 can specify the discarded sheet according to the tracking ID and manage the discarded sheet. In the document managing system, a shredder including a scanner that can communicate with the server 2 may be connected to the network. The shredder scans the sheet to be discarded and notifies the server 2 of a scanned image. The server 2 can manage the discarded sheet by acquiring the tracking ID from the scanned image.

If the printing of the management ledger is completed or if the processor 11 determines that the printing of the management ledger is unnecessary, the processor 11 notifies the server 2 of completion of the printing (ACT 47). For example, the processor 11 notifies the server 2 of the completion of the printing in association with the printed tracking ID. If the printing of the management ledger is completed or if the processor 11 determines that the printing of the management ledger is unnecessary, the processor 11 displays, on the display unit 7a, a confirmation screen (a printing completion screen) indicating the completion of the printing (ACT 48).

FIG. 15 is a diagram of an example of display of the confirmation screen. In the display example shown in FIG. 15, the processor 11 displays guidance indicating completion of copying and a confirmation button B51. If the user depresses the confirmation button B51, the processor 11 returns a display state of the display unit 7a to an initial screen. If a reference time elapses from completion of printing, the processor 11 may return the display state of the display unit 7a to the initial screen. For example, the initial screen may be a destination selection screen or may be a user authentication screen on which user authentication is performed.

Operations in the server 2 are explained below.

In a tracking copying operation, the server 2 outputs information according to a request from the digital multifunction peripheral 1. For example, the server 2 performs user authentication processing according to a user authentication request and outputs an authentication result. The server 2 creates, in response to a transmission request for destination information, a list of destinations and outputs the list as destination information. The server 2 selects, in response to a transmission request for possible operation information, executable operations for each of the destinations and outputs possible operation information including a list of the selected operations. The server 2 issues, in response to an issuance request for a tracking ID, a tracking ID, and outputs the issued tracking ID.

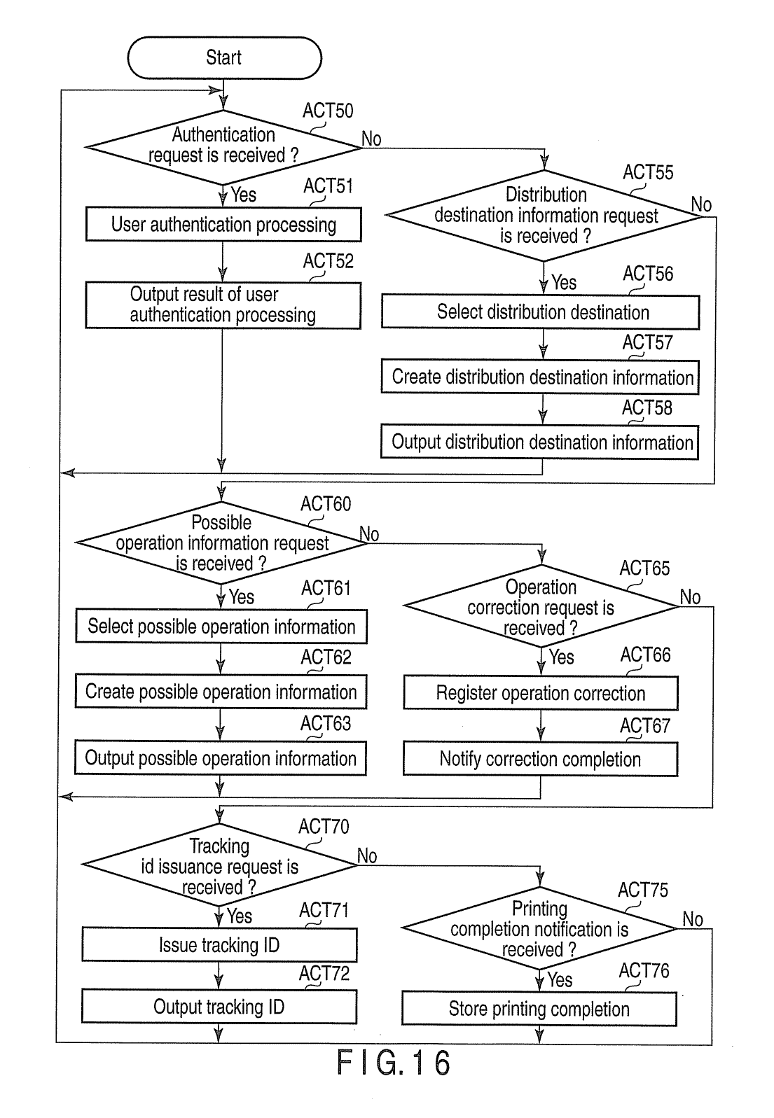

FIG. 16 is a flowchart for explaining the operation of the server 2 in tracking copying.

If the processor 21 of the server 2 receives a user authentication request from the digital multifunction peripheral 1 (YES in ACT 50), the processor 21 performs user authentication according to user information received together with the user authentication request and authentication information stored in the user management table 24a (ACT 51). For example, if the processor 21 receives a user ID and a password as the user information, the processor 21 determines whether user authentication is successful according to whether the received password coincides with authentication information corresponding to the user ID stored in the user management table 24a. After determining whether the user authentication is successful, the processor 21 transmits a result of the user authentication to the digital multifunction peripheral 1, which is a user authentication request source (ACT 52). If the authentication is successful, the processor 21 outputs information concerning the user (information such as a user name and an authority level of the user) to the digital multifunction peripheral 1 together with a result of the user authentication.

If the processor 21 of the server 2 receives a destination information request from the digital multifunction peripheral 1 (YES in ACT 55), the processor 21 creates destination information indicating users selectable as destinations of a print (ACT 56). For example, the processor 21 receives user information and a tracking ID of an original document from the digital multifunction peripheral 1 together with the destination information request. The processor 21 specifies, according to the tracking management table 24c, a document image (a document) set as a copying target corresponding to the tracking ID. The processor 21 specifies, according to the document management table 24b, an expiration date, generation number limitation, a security level, and the like as information concerning an image set as a copying target.

The processor 21 selects selectable destinations according to the information concerning the image set as the copying target (ACT 56). The processor 21 creates destination information including the selected destinations as a list (ACT 57). The processor 21 transmits the destination information including the list of the destinations to the digital multifunction peripheral 1 (ACT 58).

If the processor 21 of the server 2 receives a possible operation information request from the digital multifunction peripheral 1 (YES in ACT 60), the processor 21 selects executable operations for each of the destinations (ACT 61) and creates possible operation information indicating operation candidates of the selected destinations (ACT 62). For example, the processor 21 receives information indicating the selected destination, user authentication information, and the tracking ID of the original document from the digital multifunction peripheral 1 together with possible operation information request. The processor 21 specifies authority levels of the users at the destinations according to the user management table 24a. The processor 21 specifies an expiration date, generation number limitation, a security level, and the like as information concerning an image of a copying target corresponding to the tracking ID according to the tracking management table 24c and the document management table 24b.

The processor 21 selects, referring to the operation management table 24d, executable operations according to the authentication levels of the destinations and the security level of the image set as the copying target (ACT 61). The processor 21 selects the executable operations for the destinations to thereby create possible operation information including a list of operation candidates for each of the destinations (ACT 62). The processor 21 transmits the possible operation information including the list of the operation candidates for each of the destinations to the digital multifunction peripheral 1 (ACT 63).

If the processor 21 of the server 2 receives an operation correction request from the digital multifunction peripheral 1 (YES in ACT 65), the processor 21 corrects operation content according to received correction content (ACT 66). For example, if an expiration date is changed, the processor 21 changes an expiration date for an image set as printing target stored in the document management table 24b.

For example, if copying generation number limitation is changed, the processor 21 changes a limited number of generation number limitation for the image set as the printing target stored in the document management table 24b. The processor 21 may check presence or absence of authority for operation correction according to the authority of the user and a security level of the image set as the print target. In this case, unless the user who instructs the operation correction has the authority for operation correction, the processor 21 transmits error notification to the digital multifunction peripheral 1. If registration of the operation correction is completed, the processor 21 notifies the digital multifunction peripheral 1 that the operation correction is completed (ACT 67).

If the processor 21 of the server 2 receives an issuance request for a tracking ID from the digital multifunction peripheral 1 (YES in ACT 70), the processor 21 issues a tracking ID for each image set as a printing target for which the issuance request is received (ACT 71). The processor 21 transmits the issued tracking ID to the digital multifunction peripheral 1 in association with information indicating the image to be printed (ACT 72).

If the processor 21 of the server 2 receives notification of completion of printing from the digital multifunction peripheral 1 (YES in ACT 75), the processor 21 updates the tracking management table 24c according to information concerning a sheet for which the printing is completed (ACT 76). If the processor 21 issues the tracking ID, the processor 21 may register information concerning the tracking ID in the tracking management table 24c.

The digital multifunction peripheral 1 may execute a part or all of the pieces of processing (ACTS 50 to 76) executed by the server 2, as mentioned above. The processing in ACTS 50 to 76 is a function that can be realized by a processor executing a computer program. Therefore, the processor 11 of the digital multifunction peripheral 1 can execute the processing in ACTS 50 to 76. If the digital multifunction peripheral 1 includes the tables 24a to 24d and the processor 11 of the digital multifunction peripheral 1 executes the processing in ACTS 50 to 76, the digital multifunction peripheral 1 alone can also realize the foregoing tracking copying.

As explained above, if the digital multifunction peripheral scans an original document for copying, the document managing system extracts a tracking ID from a scanned image and presents candidates of selectable destinations to the user according to a combination of the extracted tracking ID and user information. With the document managing system, the user can grasp destinations of the original document before starting printing and can surely print an image added with a new tracking ID as an image for destinations intended by the user.

Further, if the user instructs destinations, the document managing system presents a list of selectable operations to the user for each of the destinations. With the document managing system, the user can easily grasp candidates of executable operations for each of the destinations and can easily select appropriate operations for each of the destinations. Furthermore, according to an instruction of the user, the document managing system corrects operations in the list of selectable operations or adds a new operation to the list for each of the destinations. With the document managing system, the user can perform correction or addition of an operation as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a user information acquiring unit configured to acquire user information;
a scanner configured to scan a document image added with a tracking ID;
a display configured to display a list of selectable destinations according to the tracking ID extracted from the image scanned by the scanner and the user information acquired by the user information acquiring unit;
a processing unit configured to acquire the tracking ID added to a print for destinations selected out of the list of the destinations displayed on the display and acquire print data obtained by combining the acquired tracking ID and the document image scanned by the scanner; and
a printer configured to print the print data acquired by the processing unit on a recording medium.

2. The apparatus according to claim 1, further comprising a display control unit configured to cause, if destinations are selected out of the list of the destinations, the display to display a list of candidates of executable operations for each of the selected destinations.

3. The apparatus according to claim 2, wherein the candidates of the executable operations are selected according to authority of a user of the user information.

4. The apparatus according to claim 2, wherein the candidates of the executable operations are selected according to a combination of authority of a user of the user information and the tracking ID extracted from the scanned image.

5. The apparatus according to claim 2, wherein the display control unit displays, according to an instruction for correction of an operation by a user of the user information, information indicating the corrected operation.

6. The apparatus according to claim 5, wherein the correction of the operation is a change of an expiration date.

7. The apparatus according to claim 5, wherein the correction of the operation is a change of a limited number of copies.

8. A document managing system comprising:
an image forming apparatus includes:
a user information acquiring unit configured to acquire user information;
a scanner configured to scan a document image added with a tracking ID;
a destination requesting unit configured to request the server to transmit destination information corresponding to the tracking ID extracted from the image scanned by the scanner and the user information acquired by the user information acquiring unit;
a display configured to display a list of selectable destinations according to destination information acquired from the server in response to the request by destination requesting unit;
an ID issuance requesting unit configured to request the server to transmit a tracking ID added to a print for destinations selected out of the list of the destinations displayed on the display;
a processing unit configured to acquire print data obtained by combining the tracking ID issued by the server in response to the request by the ID issuance requesting unit and the document image scanned by the scanner; and
a printer configured to print the print data acquired by the processing unit on a recording medium, and
a server includes:
a destination selecting unit configured to select selectable destinations in response to a request from the image forming apparatus;
a destination notifying unit configured to transmit destination information including a list of the destinations selected by the destination selecting unit to the image forming apparatus;
an issuing unit configured to issue a tracking ID in response to a request from the image forming apparatus; and
an ID notifying unit configured to transmit the tracking ID issued by the issuing unit to the image forming apparatus.

9. The system according to claim 8, wherein
the image forming apparatus further includes:
an operation requesting unit configured to request the server to transmit candidates of executable operations for each of the selected destinations; and
a display control unit configured to cause the display to display a list of candidates of executable operations for each of destinations acquired from the server in response to the request by the operation requesting unit, and
the server further includes:
an operation selecting unit configured to select candidates of executable operations for each of the destinations in response to a request from the image forming apparatus; and
an operation notifying unit configured to transmit possible operation information including a list of the candidates of operations selected by the operation selecting unit to the image forming apparatus.

10. The system according to claim 9, wherein the operation selecting unit selects the candidates of executable operations according to authority of a user of the user information.

11. The system according to claim 9, wherein the operation selecting unit selects the candidates of executable operations according to a combination of authority of a user of the user information and the tracking ID extracted from the scanned image.

12. The system according to claim 9, wherein
the display control unit displays information indicating a corrected operation in response to an instruction for correction of an operation by a user of the user information,
the image forming apparatus further includes a correction requesting unit configured to transmit correction content of an operation designated by the user of the user information to the server,
the display control unit causes the display to display the information indicating the corrected operation according to notification of completion of the operation correction from the server, and
the server further includes:
an operation correcting unit configured to register the correction of the operation in response to a request from the image forming apparatus; and
an operation notifying unit configured to transmit the notification of the completion of the operation correction to the image forming apparatus according to the registration of the correction of the operation by the operation correcting unit.

13. The system according to claim 12, wherein the correction of the operation is a change of an expiration date.

14. The system according to claim 12, wherein the correction of the operation is a change of a limited number of copies.

15. An image forming method comprising:
acquiring user information;
scanning a document image added with a tracking ID;
displaying a list of selectable destinations according to the tracking ID extracted from the scanned image and the acquired user information;
acquiring the tracking ID added to a print for destinations selected out of the displayed list of the destinations;
acquiring print data obtained by combining the acquired tracking ID and the scanned document image; and
printing the acquired print data on a recording medium.

16. The method according to claim 15, further comprising displaying, if destinations are selected out of the list of the destinations, a list of candidates of executable operations for each of the selected destinations.

17. The method according to claim 16, wherein the candidates of the executable operations are selected according to authority of a user of the user information.

18. The method according to claim 15, further comprising displaying, according to an instruction for correction of an operation by a user of the user information, information indicating the corrected operation.

19. The method according to claim 18, wherein the correction of the operation is a change of an expiration date.

20. The method according to claim 18, wherein the correction of the operation is a change of a limited number of copies.
